(19) United States
(12) Patent Application Publication
(10) Pub. No.: US 2009/0199127 A1
(43) Pub. Date: Aug. 6, 2009

(54) PREVIEWING TARGET DISPLAY AREAS

(75) Inventors: CHAITANYA DEV SAREEN, SEATTLE, WA (US); ROBERT JAMES JARRETT, SNOHOMISH, WA (US); STEPHAN HOEFNAGELS, SEATTLE, WA (US); DAVID ANDREW MATTHEWS, SEATTLE, WA (US); PAI-HUNG CHEN, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/023,157

(22) Filed: Jan. 31, 2008

(51) Int. Cl. G06F 3/048

(52) U.S. Cl. 715/781

(57) ABSTRACT

Systems, methods, computer-readable media, and graphical user interfaces for previewing target display areas are provided. A preview indication that indicates a desire to preview a target display area is detected. Upon detecting a preview indication, events are associated with display areas. The preview events associated with the respective display areas are applied to the display areas such that a preview of the target display area is temporarily presented in an inactive state. In one embodiment, the preview events include changing relative opacity and/or transparency such that the target display area is visibly presented.

### BACKGROUND

Display areas, such as windows, are oftentimes obscured in that such display areas, or portions thereof, are not readily visible to a user. An obscured display area can exist, for example, when the display area has a minimized state or the display area is overlapped by (i.e., positioned behind) another display area. To view an obscured display area, a user can provide a command, such as a keyboard stroke or mouse click, so that the desired display area becomes the active display area and is readily visible to the user.

### BRIEF SUMMARY

Embodiments of the present invention relate to systems, graphical user interfaces, and computer-readable media for previewing target display areas. A preview indication that indicates a desire to preview a target display area is detected. Upon detecting a preview indication, events are associated with display areas. In one embodiment, preview events may be associated with each of the display areas presented within a display device or with each of the display areas comprising window display areas. The preview events associated with the respective display areas are applied to the display areas such that a preview of the target display area is temporarily presented in an inactive state. In one embodiment, the preview events include changing relative opacity and/or transparency such that the target display area is visibly presented. Such a preview of a target display area includes at least a display area content, a display area size, and a display area location as if the target display area were selected to be an active display area.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a block diagram of an exemplary computer system for use in implementing an embodiment, in accordance with the present invention;

FIG. 4 is a flow diagram illustrating an exemplary method for previewing a target display area, in accordance with an embodiment of the present invention;

FIG. 5 illustrates an exemplary display of an initial view, in accordance with an embodiment of the present invention;

FIG. 6 illustrates an exemplary display of a preview of a window target display area, in accordance with an embodiment of the present invention;

FIG. 7 illustrates an exemplary display of a destination view comprising an initial view, in accordance with an embodiment of the present invention;

FIG. 8 illustrates an exemplary display of a destination view comprising a target view, in accordance with an embodiment of the present invention;

FIG. 9 illustrates an exemplary display of an initial view, in accordance with an embodiment of the invention;

FIG. 10 illustrates an exemplary display of a transparency event partially applied to window display areas, in accordance with an embodiment of the invention;

FIG. 11 illustrates an exemplary display of a desktop target display area, in accordance with an embodiment of the invention;

FIG. 12 illustrates an exemplary display of a destination view comprising an initial view, in accordance with an embodiment of the invention; and

FIG. 13 illustrates an exemplary display of a destination view comprising a target view, in accordance with an embodiment of the invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements or methods employed, the terms should not be interpreted as implying any particular order among or between various steps herein disclosed unless and except when the order of individual steps is explicitly described.

Embodiments of the present invention provide systems, methods, and computer-readable media for previewing target display areas. Accordingly, in one aspect, the present invention provides one or more computer-readable media having computer-executable instructions embodied thereon that, when executed, perform a method for previewing target display areas. The method includes detecting a preview indication to preview a target display area, the target display area comprising an actual display area for which a preview is desired; and in response to detecting the preview indication, displaying a preview of the target display area, the preview comprising a temporary view of the target display area having an inactive state.

In another aspect, the present invention provides a computerized system for previewing target display areas. The system includes a preview detecting component configured to detect a preview indication to preview a target display area, the target display area comprising an actual display area for which a preview is desired, wherein the actual display area comprises at least a target display area content, a target display area size, and a target display area location as if selected to be an active display area; an event associating component is configured to associate one or more preview events with one or more display areas presented to a user via a display device; an event applying component configured to apply the one or more preview events to the corresponding display areas, wherein, upon applying the one or more preview events, a preview of the target display area is displayed having an inactive state.

In a further aspect, the present invention provides a method for previewing target display areas. The method includes receiving an indication to preview a desktop target display area, the desktop target display area comprising an actual display area for which a preview is initiated; referencing each window display area presented within a display device, wherein each window display area comprises one of an application window, a document window, a palette window, or a dialogue box; applying one or more preview events to each window display area, wherein at least one of the one or more preview events applied to each window display area comprises a transparency event, the transparency event providing transparency to each window display area such that a preview of the desktop target display area having an inactive state results; receiving a destination indication requesting a destination view comprising an initial view of each window display area initially presented within the device; and presenting the initial view of each window display area.

Having briefly described an overview of embodiments of the present invention, an exemplary operating environment suitable for implementing embodiments hereof is described below.

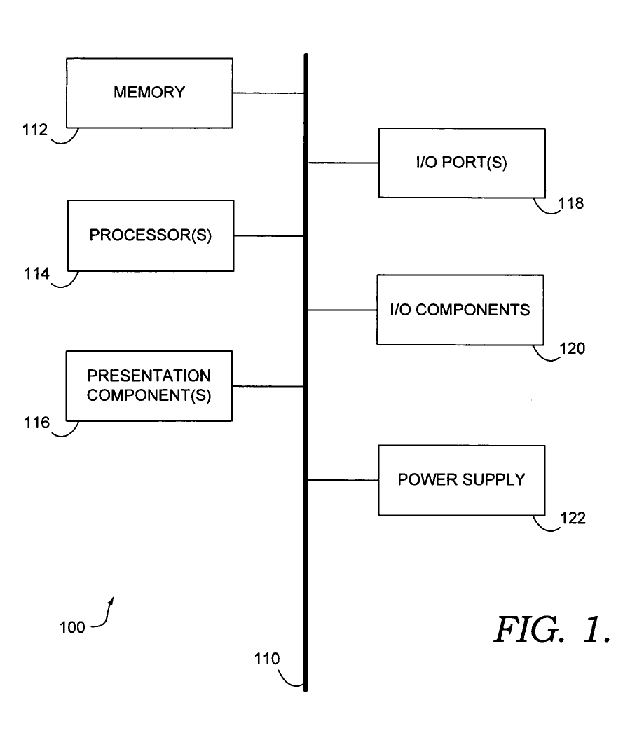

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation component include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

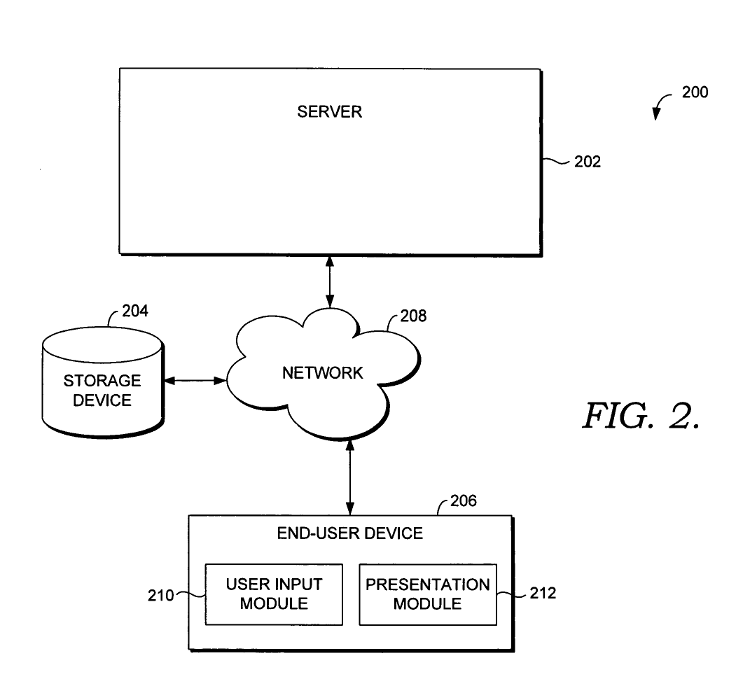

With reference to FIG. 2, a block diagram is illustrated that shows an exemplary computing system architecture 200 configured for use in implementing an embodiment of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with one or more display areas. In embodiments, the storage device 204 is configured to be searchable for one or more of the items stored in association therewith. It will be understood and appreciated by those of ordinary skill in the art that the information stored in the storage device 204 may be configurable and may include any information relevant to one or more display areas. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or ore of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single box, one skilled in the art will appreciate that the server 202 is scalable. For example, the server 202 may in actuality include 500 servers in communication. Moreover, the storage device 204 may be included within the server 202 and/or end-user device 206 as a computer-storage medium. The single unit depictions are meant for clarity, not to limit the scope of embodiments in any form.

As shown in FIG. 2, the end-user device 206 includes a user input module 210 and a presentation module 212. In some embodiments, one or more of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for, among other things, receiving an indication to preview a target display area, e.g., a window. Typically, such an indication is input via a user interface (not shown) associated with the end-user device 206, or the like. Upon receiving an indication to preview a target display area, the presentation module 212 of the end-user device 206 is configured for presenting a preview of a target display area. In one embodiment, the presentation module 212 presents a preview of a target display area utilizing a display device associated with the end-user device 206. Embodiments, however, are not intended to be limited to visual display but rather may also include audio presentation, combined audio/video presentation, and the like.

As previously set forth, embodiments of the present invention relate to computing systems and methods for previewing target display areas. As used herein, the phrase “target display area” refers to an actual display area for which a preview is initiated, desired, and/or intended. A display area refers any visual area having a user interface that is presented via a display device. A display area may include, for example, a desktop, a window, and the like. A desktop display area is a display area on which application icons, folder icons, document icons, and desktop tools (e.g., calendar, clock/time, weather, stocks, and RSS feeds) can be presented. A window display area may include, for example, an application window, a document window, a palette window, a dialogue box, and the like.

An actual display area, as used herein, refers to any display area having at least a display area content, a display area size, and a display area location as if it were selected to be an active display area. The display area content refers to the content presented within the display area. Display area size refers to the size of the display area, such as, for example, window width, window height, and the like. The display area location refers to the location at which the display area is positioned within the display device. A display area is active, i.e., has an active state, for example, if it is the display area to which received input, such as user input (e.g., keys typed on a keyboard), is directed.

By way of example only, assume a display area has a minimized state. The actual display area is the view of the display area that is presented to a user in instances where the display area is activated (e.g., restored). That is, the actual display area includes the display area size, display area location, and display area content as if selected by a user to become active (e.g., user selects a particular taskbar button to restore the display area).

A preview of a target display area, as used herein, refers to a temporary view of a target display area having an inactive state. A display area has an inactive state, for example, if it is a display area to which received input, such as user input (e.g., keys typed on a keyboard), is not directed. Accordingly, a preview of a target display area enables a display area to become temporarily visible to a user without modifying an active or inactive state of the target display area or other display areas. For example, assume a user is viewing a first window having an active state. Further assume that the user would like to preview a second window having an inactive state. The user can preview the second window as though the user selected to make the second window active. In such a case, however, neither the active state of the first window nor the inactive state of the second window are modified and, as such, the user can immediately resume to viewing the first window having the active state.

A preview of a target display area may be desirable for, among other things, viewing an obscured display area without activating the target display area. In embodiments, a target display area can be at least partially obscured such that at least a portion of the display area presented on a display device is not readily visible to a user. That is, a user viewing a display device is unable to initially view, without providing user input, at least a portion of a target display area. By way of example only, a target display area, such as a window, may be presented in a minimized state such that the target display area is not readily visible to a user. Alternatively, a target display area, or a portion thereof, may be positioned behind (i.e., overlapped by or covered by) another display area being presented. As such, the target display area is at least partially obscured and, accordingly, is not readily visible to a user.

Accordingly, a user may benefit from a preview of a target display area in instances that a user wishes to temporarily view an inactive display area to obtain information and, thereafter, desires to return to the initial display area without modifying states of the display areas. Further, because a preview reveals an actual display area, including the actual display area size, content, and location, a user has a better opportunity to view and recognize content provided within the display area. By way of example only, assume that a user is preparing an article utilizing a document display area that is overlapping a web browser display area such that the web browser display areas is not readily visible. Further assume that the user would like to view information provided within the web browser display area. Rather than activating the web browser display area to view the content within the web browser display area, the user can preview the web browser having an inactive state such that the user can resume working within the document display area without having to reactivate the document display area.

In addition, a user may similarly benefit from a preview of a target display area in instances that the user would like to navigate to a particular display area, but wishes to verify that the desired display area will be activated upon selection. Further, because a preview reveals an actual display area, including the actual display area size, content, and location, a user has a better opportunity to quickly recognize whether the display area is desired. By way of example, assume that a user is viewing an active display area that is overlapping two document display areas such that the document display areas are not readily visible. Further assume that the user desires to continue preparing an article utilizing one of the document display areas, but, based on the available taskbar buttons, is unable to easily recognize which of the two web browser display areas is desired. Rather than randomly selecting to activate one of the document display areas in hopes that it is the correct document display area, the user can preview the web browser in an inactive state. As such, the user can adequately identify the document display area prior to any activation of the display area.

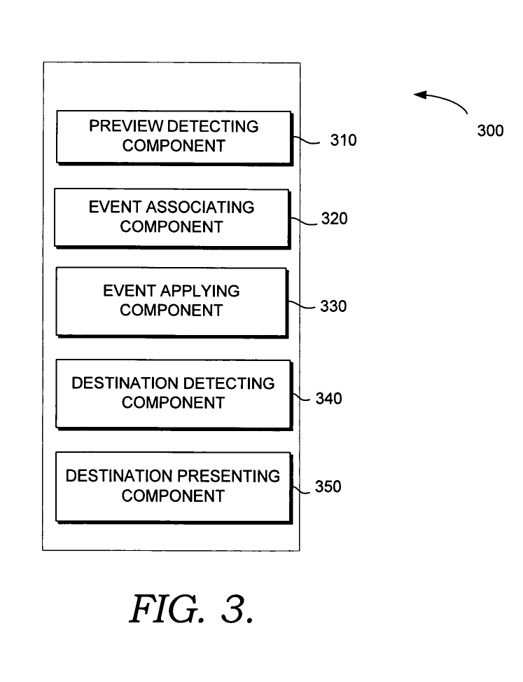

FIG. 3 illustrates an exemplary computer system 300 for previewing target display areas. As shown in FIG. 3, an exemplary computer system 300 includes a preview detecting component 310, an event associating component 320, an event applying component 330, a destination detecting component 340, and a destination presenting component 350. In some embodiments, one or more of the illustrated components may be implemented as stand-alone applications. In other embodiments, one or more of the illustrated components may be integrated directly into the operating system of a server (e.g., server 202), a cluster of servers (not shown) and/or an end-user device (e.g., end-user device 206). It will be understood by those of ordinary skill in the art that the components illustrated in FIG. 3 are exemplary in nature and in number and should not be construed as limiting. Any number of components may be employed to achieve the desired functionality within the scope of embodiments hereof. Further, components may be located on any number of servers or computers.

The preview detecting component 310 is configured to detect a preview indication. A preview indication, as used herein, provides an indication to initiate a preview of a target display area. In one embodiment, preview detecting component 310 detects a preview indication provided by a user. A user may provide such an indication by selecting a display area identifier that corresponds with a target display area. A display area identifier refers to any feature associated with a display area that identifies the display area. In embodiments, a display area identifier can include, for example, an icon, e.g., a “show desktop” icon; a thumbnail, e.g., a reduced size version of a display area; a display area, or a portion thereof; or any other feature that may identify a display area. A user may select a display area identifier by, among other things, clicking or double-clicking on the display area identifier, right-clicking on the display area identifier, hovering over the display area identifier, dragging and dropping the display area identifier, providing an audio command, utilizing a touch screen, utilizing a keyboard shortcut sequence (e.g., using alt-tab keyboard shortcut sequence), and the like.

In embodiments, preview detecting component 310 may detect an indication to initiate a preview of a target display area upon attaining a certain threshold and/or parameter. For example, assume that hovering over a display area identifier provides an indication to initiate the previewing of a display area. In such a case, the preview detecting component 310 may detect the indication after a display area identifier is hovered over for a predetermined amount of time, e.g., two seconds.

The event associating component 320 is configured to associate one or more preview events with one or more display areas. A preview event refers to any event that can be applied to a display area such that a target display area can be previewed. As such, a preview event may include, for example, an opacity event, a transparency event, a minimization event, a location event, a size event, a z-order event, or the like. An opacity event refers to a modification of the opaqueness of a display area. A transparency event refers to a modification of the transparency of a display area. A minimization event refers to modifying the state of a display area such that the display area has a minimized state. A location event refers to modifying the location of a display area. A size event refers to modifying the size of a display area. A z-order event refers to modifying the z-order of a display area (i.e., the order of overlapping objects). Any number of preview events can be associated with a single display area. For example, both a transparency event and a z-order event may be associated with a particular display area.

In one embodiment, event associating component 320 may be configured to reference, determine, and/or identify display areas, or a portion thereof, presented on a display device. For example, event associating component 320 may reference each display area presented on a display device such that preview events can be applied to each display area, if desired. Alternatively, event associating component 320 may reference a portion of the display areas presented on a display device. For example, event associating component 320 may reference each display area presented on a display device that is positioned in front of the target display area or each window display area presented on a display device other than a target display area.

Preview events may be associated with a display area based on one or more display area attributes. A display area attribute refers to any characteristic of a display area. Display area attributes may include, for example, a display area state (e.g., maximized, minimized, restored), a display area z-order, a display area size, a display area location, a display area type (e.g., window, desktop, or the like), a target display area indicator (e.g., indication that the display area is the target display), and the like. For example, for each display area having a display area z-order that positions the display area in front of the target display area, a particular event, such as a transparency event, may be associated with such display areas. In an embodiment where preview events are associated with display areas based on display area attributes, the event associating component 320 may be configured to determine, identify, or reference one or more display area attributes associated with display areas such that a preview event can be applied. For example, event associating component 320 may determine, reference, or identify the z-order for each window display area presented on a display device.

One skilled in the art will appreciate that any combination of preview events can be associated with any display areas presented on a display device. By way of example only, assume that a user indicates a desire to preview a target display area having a z-order that positions the target display area behind a first display area and in front of a second display area. Upon referencing the z-order associated with each of the display areas, the event associating component 320 may apply a transparency event to the first display area that overlaps the target display area. Alternatively, the event associating component 320 may apply a z-order event to position the target display area in front of the first display area and second display area.

The event applying component 330 is configured to apply one or more preview events to the appropriate display areas such that a preview for a target display area is presented. As such, the event applying component 330 may, for example, temporarily modify the opacity and/or transparency of display areas, the z-order of display areas, the state of display orders, the size and/or location of display areas, and the like. One skilled in the art will appreciate that, in embodiments, the preview event is temporarily applied during the preview of the target display area.

The destination detecting component 340 is configured to detect a destination indication. A destination indication, as used herein, provides an indication of a desired, initiated, or intended destination view. In one case, a destination view may comprise the initial view presented on a display device prior to the preview of the target display area. An initial view refers to the view presented to a user at the instant a preview of a target display area is initiated. In another case, the destination view may comprise a target view. A target view refers to the view presented on a display device after a user selects to activate a target display area. In yet another case, the destination view may comprise a secondary preview. A secondary preview refers to a preview of another target display area.

In one embodiment, destination detecting component 340 detects a destination indication provided by a user. In an embodiment where the desired destination view comprises an initial view, a user may provide a destination indication by utilizing any method that provides an indication to complete the preview or to return to the initial view. For example, a user may remove a selecting device such that it no longer hovers over the display area identifier. In an embodiment where the desired destination view comprises a target view, a user may provide a destination indication by utilizing any method that provides an indication to activate the target display area. For example, where a user hovers over a display area identifier to initiate a preview of a target display area, the user may click or double-click on the display area identifier to indicate that a target view is desired. In an embodiment where the desired destination view comprises a secondary preview, a user may provide such a destination indication by utilizing any method that provides an indication to preview another target display area. For example, where a user utilizes a keyboard shortcut, such as alt-tab, to initiate a preview of a target display area, the user may utilize the same keyboard shortcut or an alternative keyboard shortcut to indicate that a secondary preview is desired.

In embodiments, destination detecting component 340 may detect a destination indication upon attaining a certain threshold and/or parameter. For example, assume that removing a selecting device (e.g., a pointer or mouse) from hovering over a display area identifier provides an indication to view a destination display area. In such a case, the destination detecting component 340 may detect the indication after the selecting device is removed from hovering over the display area for a predetermined amount of time, e.g., two seconds.

In another embodiment, a destination indication may be automatically provided. In such an embodiment, a destination indication may be automatically provided based on the occurrence of an event. Such an event may include, for example, the occurrence of a time or time duration. For example, after the preview of a target display area is visible to a user for a specific time duration, e.g., five seconds, a destination indication may be provided.

One skilled in the art will appreciate that any number of destination views may exist. In an embodiment where more than one destination view may be available, destination detecting component 340 may be configured to associate the detected destination indication with the destination view to be presented. For example, destination detection component 340 may detect that a click on the display are identifier indicates a destination view comprising a target view is to be presented.

The destination presenting component 350 is configured to present the destination view. In an embodiment where the destination view comprises the initial view, destination presenting component 350 presents the initial view presented on a display device that existed at the instant a preview of a target display area is initiated. As such, the presented destination view includes presenting the display areas having the same content, size, position, z-order, and the like, as the display areas presented prior to the preview of the target display area. In such an embodiment, if modifications were made to any display areas for the preview of the target display area, such modifications may be reverted.

In an embodiment where the destination view comprises a target view, destination presenting component 350 presents the view presented on a display device that exists after a user selects to activate a target display area. In an embodiment where the destination view comprises a secondary preview, the destination presenting component 350 presents a preview of another target display area. In such embodiments, destination presenting component 350 may make modifications to display areas such that a target display area is presented in an active state or that a secondary preview is presented to a user.

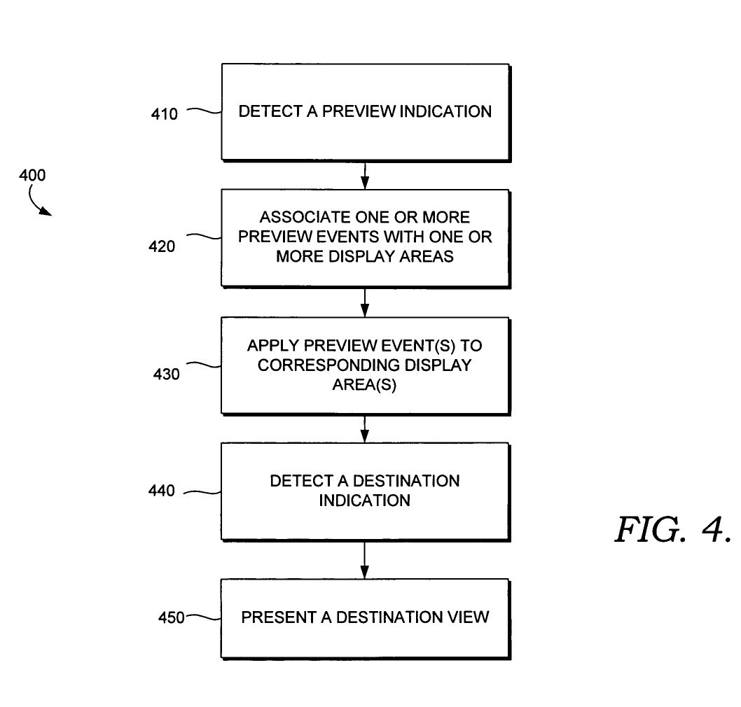

Referring now to FIG. 4, an exemplary method for previewing a target display area is presented, in accordance with an embodiment of the present invention. Initially, as indicated at block 410, a preview indication is detected. Such a preview indication provides an indication that a preview of a target display area is desired, intended, or initiated. Subsequently, at block 420, one or more preview events are associated with one or more display areas. Preview events may be associated with display areas based on display area attributes, such as the display area z-order, the display area state, and the like. Where the target display area comprises a desktop target display area, in one embodiment, a transparency event may be associated with each window display area. Where the target display area comprises a window target display area, in one embodiment, a transparency event may be associated with each display area positioned in front of the window target display area, with each window display area other than the target display area, or with each window display area. At block 430, preview events are applied to the corresponding display areas. A destination indication is detected at block 440. Thereafter, a destination view is presented. This is indicated at block 450. In one embodiment, the destination view may be based on the destination indication detected. For example, assume a user removes a selecting device from hovering over a display area identifier. In such a case, an initial view may be presented.

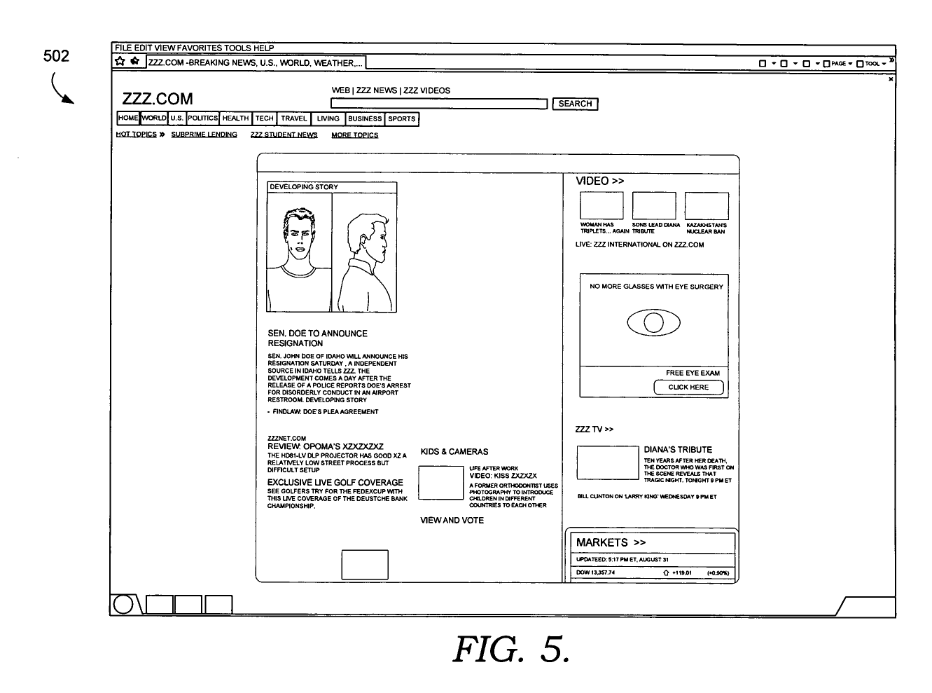

FIGS. 5-13 illustrate exemplary displays of graphical user interfaces for previewing target display areas, according to embodiments of the present invention. The display areas may be any display areas presented on a display device. The display areas described herein may be displayed on a computing device, such as end-user device 206. A user can interact with the display areas using well known input components—such as, for example, a mouse, joystick, stylus, touch screen, keyboard, or the like.

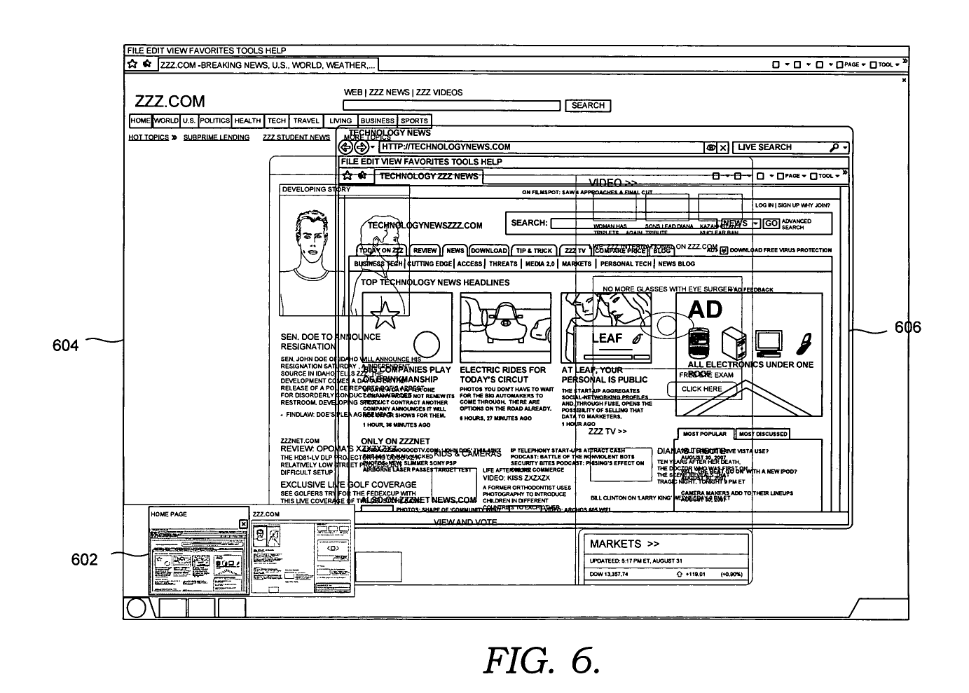

By way of illustration, the exemplary displays of FIGS. 5-8 show a preview of a window target display area, according to embodiments of the present invention. Suppose, for instance, that a user views a first webpage display area 502 of FIG. 5 having an active state. As such, received user input is directed to the first webpage display area 502. Suppose further that the user decides to preview a target display area comprising another webpage display area. In particular, the user provides a preview indication by hovering over a target display area identifier 602 of FIG. 6 (e.g., a thumbnail). Upon hovering over the target display identifier 602 of FIG. 6, one or more preview events are associated with display areas. As shown in FIG. 6, a transparency event can be applied to display areas presented within the display device. Such a transparency event presents the first webpage display area 604 slightly transparent via an alpha blend and the second webpage display area 606 slightly transparent via an alpha blend. Although both first webpage display area 604 and second webpage display area 606 are slightly transparent, the relative transparency of first webpage display area 604 and the second webpage display area 606 make it so that second webpage display area 606 appears to be in the foreground. As one skilled in the art will appreciate, any number of preview events can be applied so that a preview of a target display area results. For example, the first webpage display area 604 could become completely transparent.

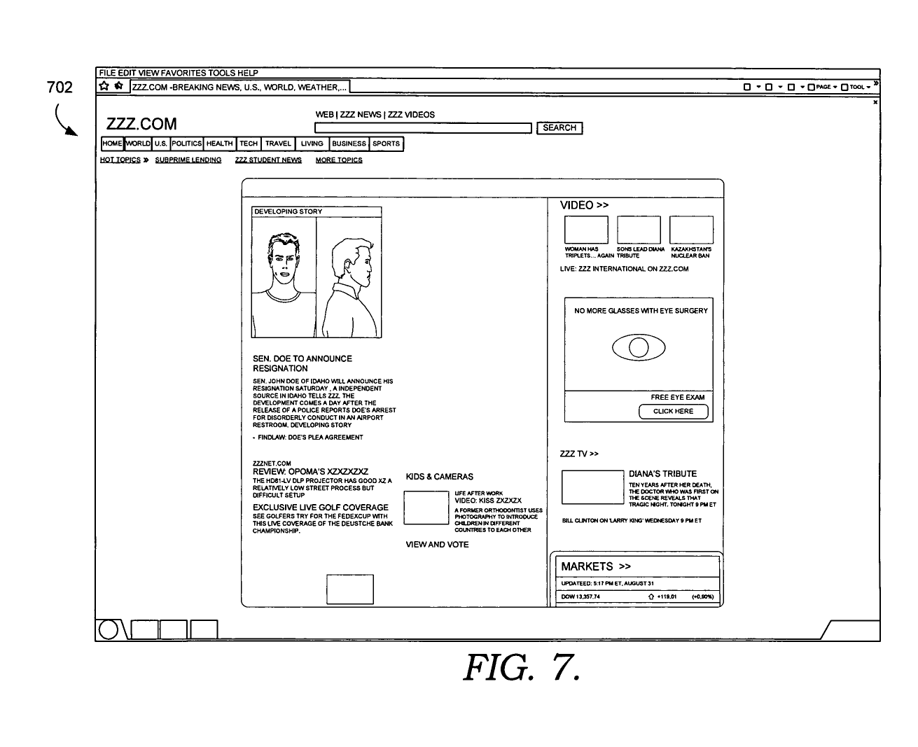

Upon previewing the second webpage display area 606, suppose first that the user wishes to return to the initial view including the first webpage display area. As such, the user provides a destination indication, by, for example, removing the selecting device from hovering over target display identifier 602, to resume to an initial view of the first webpage display area. Upon removing the selecting device from hovering over target display identifier 602, the initial view 702 is resumed, as illustrated in FIG. 7.

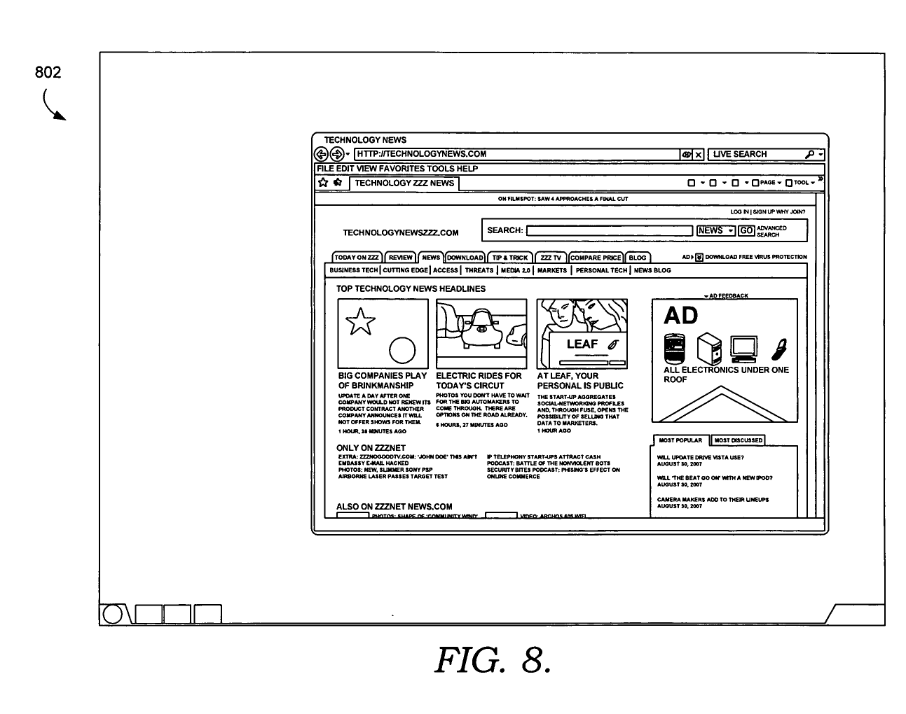

Returning to FIG. 6, now suppose that after the user previews the second webpage display area 606, rather than returning to an initial view, the user desires to activate the second webpage display area 606. As such, the user provides a destination indication, by, for example, clicking on the target display identifier 602 associated with the second webpage display area 606. Upon clicking on the target display identifier 602, the target display area 802 is activated, as illustrated in FIG. 8.

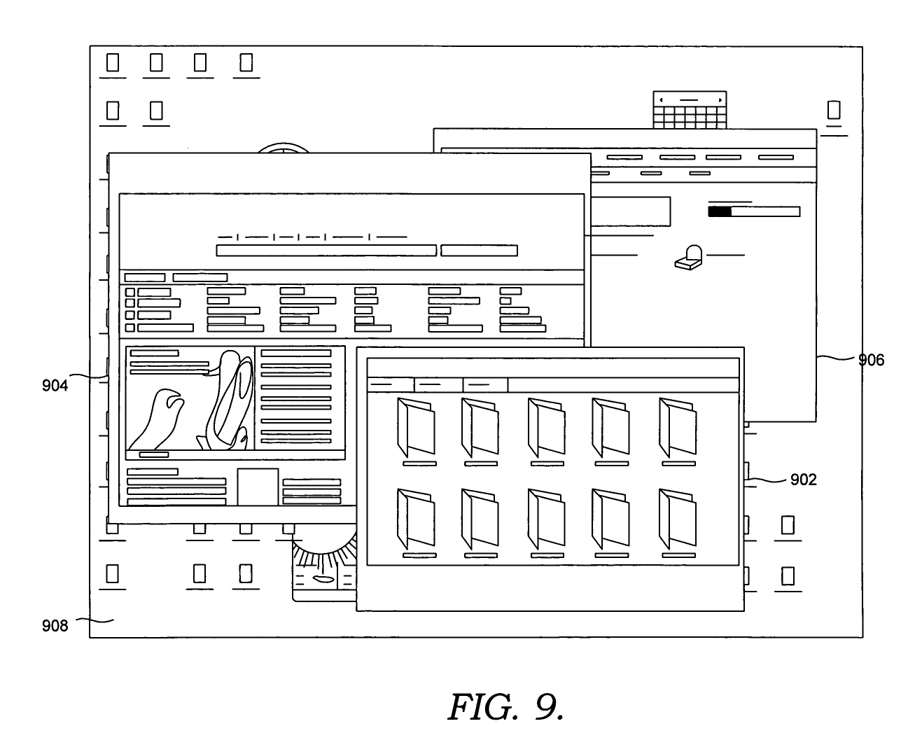

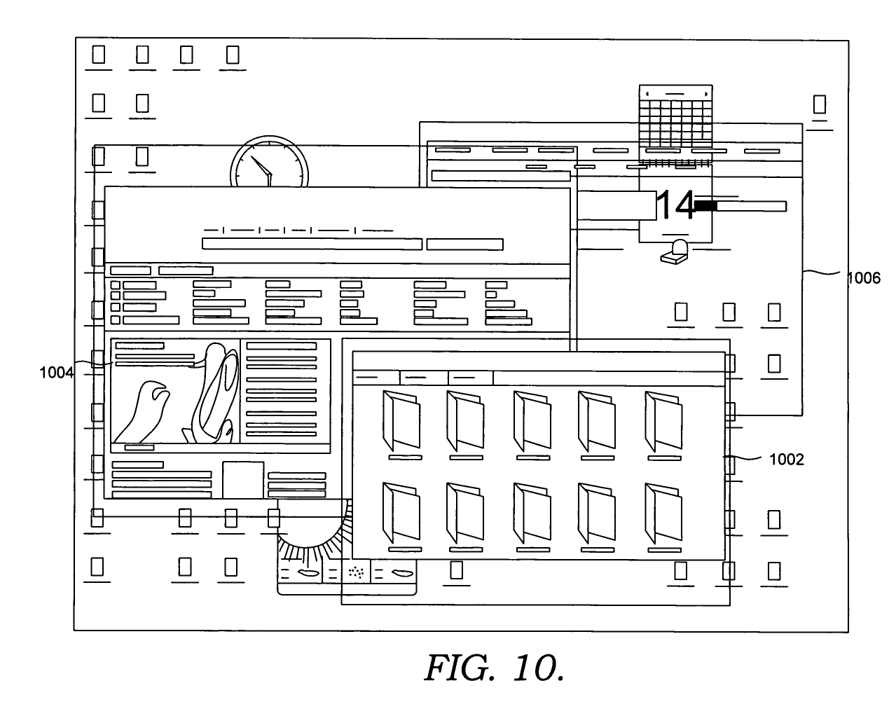

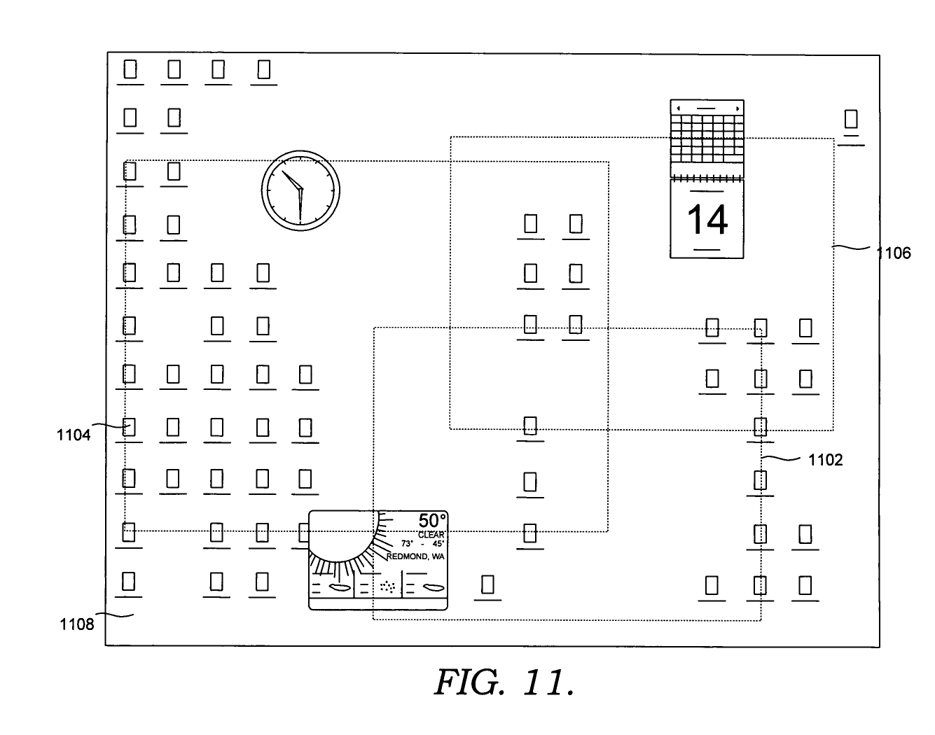

By way of further illustration, the exemplary displays of FIGS. 9-13 show a preview of a desktop target display area, according to embodiments of the present invention. Suppose, for instance, that a user views a first display area 902, a second display area 904, and a third display area 906 of FIG. 9. Suppose further that the user decides to preview a target display area comprising a desktop display area. In particular, the user provides a preview indication by hovering over a target display area identifier, such as the desktop display area 908 of FIG. 9. One skilled in the art will appreciate that a target display area identifier may be an icon (e.g., a desktop icon), a taskbar button, or the like. Upon hovering over the target display identifier 908 of FIG. 9, one or more preview events are associated with display areas 902, 904, and 906. As shown in FIG. 10, a transparency event can be applied to display areas presented within the display device. Such a transparency event presents each of the first display area 1002, the second display area 1004, and the third display area 1006 slightly transparent via an alpha blend. The transparency event applied to each of the first display area 1102, the second display area 1104, and the third display area 1106 of FIG. 11 make it so that the target display area 1108 appears in the foreground. In one embodiment, the events applied to the display areas may include features applied to the display areas such that the display areas appear as a glass window. For example, the display area edges may be blurred while the interior portion of the display areas may have a glossy or shiny effect.

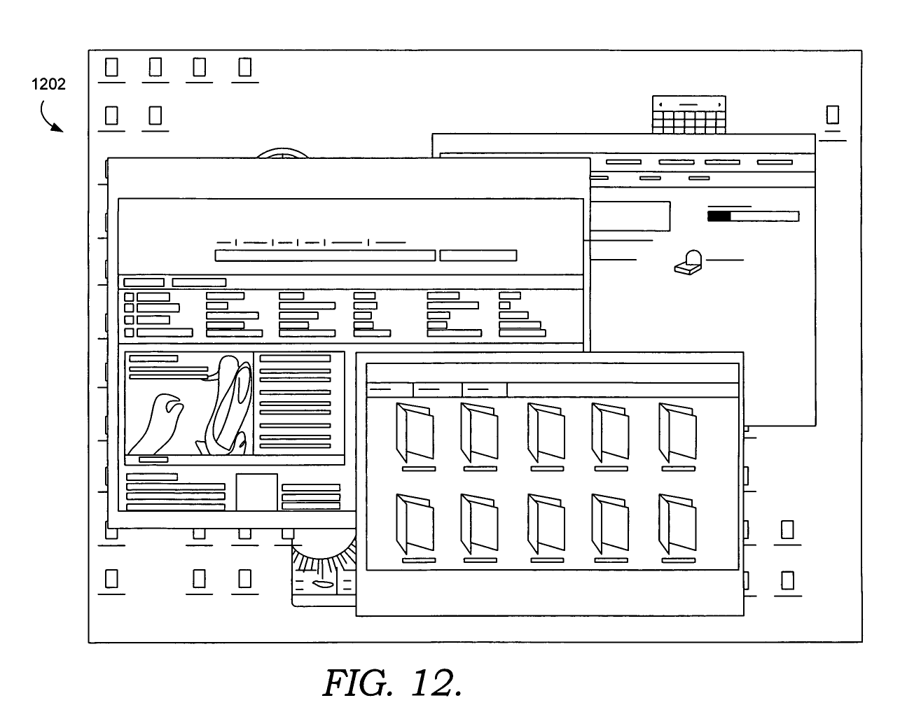

Upon previewing the target display area 1108, suppose first that the user wishes to return to the initial view presented within the display device. As such, the user provides a destination indication by, for example, removing the selecting device from hovering over the target display area 1108, to resume to an initial view. Upon removing the selecting device from hovering over target display area 1108, the initial view 1202 is resumed, as illustrated in FIG. 12.

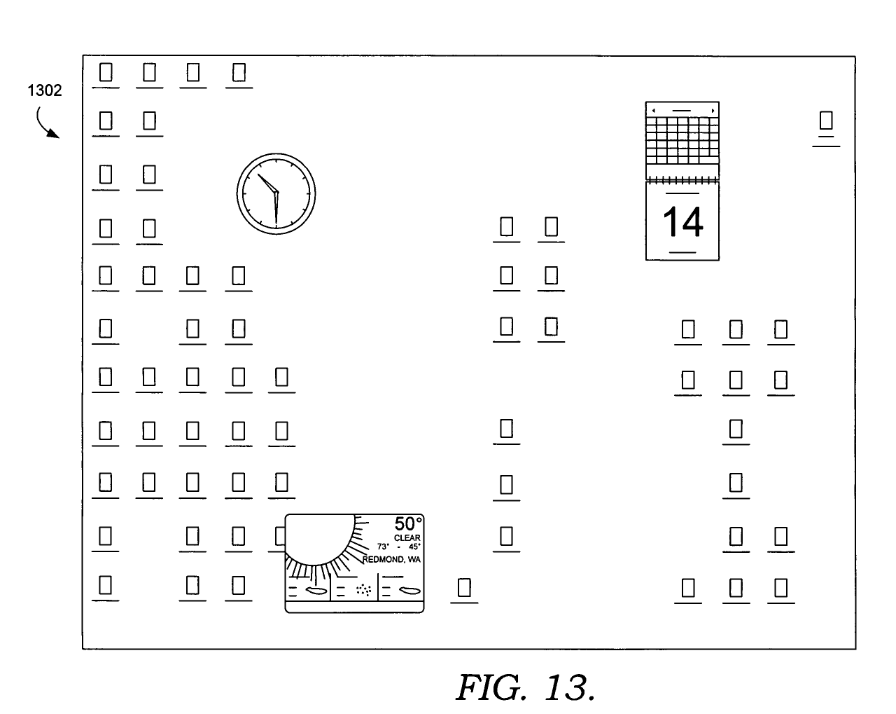

Returning to FIG. 11, now suppose that after the user previews the target display area 1108, rather than returning to the initial view, the user desires to activate the target display area 1108. As such, the user provides a destination indication by, for example, clicking on the target display area 1108. Upon clicking on the target display area 1108, the target display area 1302 is activated, as illustrated in FIG. 13.

Embodiments described herein are intended in all respects to be illustrative rather than restrictive. Alternative embodiments will become apparent to those of ordinary skill in the art without departing from the scope of embodiments described herein.

From the foregoing, it will be seen that embodiments of the present invention are well adapted to attain ends and objects set forth above, together with other advantages which are obvious and inherent to the systems and methods described. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for previewing target display areas, the method comprising:
detecting a preview indication to preview a target display area, the target display area comprising an actual display area for which a preview is desired; and
in response to detecting the preview indication, displaying a preview of the target display area, the preview comprising a temporary view of the target display area having an inactive state.

2. The computer-readable media of claim 1, wherein the target display area comprises a window or a desktop.

3. The computer-readable media of claim 1, wherein the preview indication is provided by a user selection of a display area identifier.

4. The computer-readable media of claim 3, wherein the user selection comprises hovering a selecting device over the display area identifier.

5. The computer-readable media of claim 1, wherein the actual display area comprises at least a target display area content, a target display area size, and a target display area location as if selected to be an active display area.

6. The computer-readable media of claim 1 further comprising detecting a destination indication, wherein the destination indication comprises an indication to display a desired destination view.

7. The computer-readable media of claim 6, wherein the destination view comprises an initial view.

8. The computer-readable media of claim 6, wherein the destination view comprises a target view.

9. The computer-readable media of claim 6, wherein the destination view comprises a secondary preview.

10. The computer-readable media of claim 3, wherein the display area identifier comprises an icon, a thumbnail, or a display area.

11. A computerized system for previewing target display areas, the system comprising:
a preview detecting component configured to detect a preview indication to preview a target display area, the target display area comprising an actual display area for which a preview is desired, wherein the actual display area comprises at least a target display area content, a target display area size, and a target display area location as if selected to be an active display area;
an event associating component is configured to associate one or more preview events with one or more display areas presented to a user via a display device; and
an event applying component configured to apply the one or more preview events to the corresponding display areas, wherein, upon applying the one or more preview events, a preview of the target display area is displayed having an inactive state.

12. The system of claim 11, wherein the preview detecting component detects a preview indication provided by a user.

13. The system of claim 11, wherein the event associating component identifies one or more display areas presented on a display device.

14. The system of claim 11, wherein the event associating component associates one or more preview events with one or more display areas based on one or more display area attributes.

15. The system of claim 14, wherein the one or more display area attributes comprise a display area state, a display area z-order, a display area size, a display area location, a display area type, a target display area indicator, or a combination thereof.

16. The system of claim 11 further comprising a destination detecting component configured to detect a destination indication that indicates a destination view desired by a user, wherein the destination view comprises one of an initial view, a target view, or a secondary preview.

17. The system of claim 16 further comprising a destination applying component configured to present the destination view.

18. The system of claim 11, wherein the one or more preview events comprise an opacity event, a transparency event, a minimization event, a location event, a size event, a z-order event, or a combination thereof.

19. The system of claim 11, wherein the target display area comprises a window display area or a desktop display area.

20. A method for previewing target display areas, the method comprising:
receiving an indication to preview a desktop target display area, the desktop target display area comprising an actual display area for which a preview is initiated;
referencing each window display area presented within a display device, wherein each window display area comprises one of an application window, a document window, a palette window, or a dialogue box;
applying one or more preview events to each window display area, wherein at least one of the one or more preview events applied to each window display area comprises a transparency event, the transparency event providing transparency to each window display area such that a preview of the desktop target display area having an inactive state results;
receiving a destination indication requesting a destination view comprising an initial view of each window display area initially presented within the device; and
presenting the initial view of each window display area.
